(19) United States
(12) Patent Application Publication
(10) Pub. No.: US 2007/0190918 A1
(43) Pub. Date: Aug. 16, 2007

(54) Air flow regulation device, especially for the air conditioning system of a motor vehicle

(75) Inventor: Michael Komowski, Weil der Stadt-Merklingen (DE)

Correspondence Address: FOLEY AND LARDNER LLP;SUITE 500, 3000 K STREET NW, WASHINGTON, DC, 20007, US

(73) Assignee: BEHR GMBH & CO. KG, STUTTGART (DE)

(21) Appl. No.: 10/583,967

(22) PCT Filed: Nov. 23, 2004
(86) PCT No.: PCT/EP04/13268

§ 371 Date: Jun. 21, 2006

(30) Foreign Application Priority Data
Dec. 22, 2003 (DE) 103 61 108.8

(51) Int. Cl. B61D 27/00; F16K 1/16; F25D 17/04; F16K 5/00; B60H 1/00

(52) U.S. Cl. 454/109; 62/309; 251/302; 251/304

(57) ABSTRACT

The invention relates to an air flow regulation device comprising a housing and a flap arrangement (1) and to an air-conditioner comprising such an air flow regulation device. The flap arrangement (3) comprises at least two flap parts (3) for opening and closing an opening, which can be swiveled about swiveling axes (4) that extend in parallel. The two flap parts (3), in the closed state of the flap arrangement (1), rest on one another and roll off and/or slide on one another when at least one flap part is displaced from the closed state to a partially opened state or vice versa. The flap parts (3), at least in the area of their end sections (5) that rest on one another in the closed state, are elastic.

The invention relates to an device having a housing and a flap arrangement for regulating an air flow, in particular for a motor vehicle air conditioning system, according to the preamble of claim 1, and to an air conditioning unit, having an air flow regulating device, according to claim 9.

In a conventional blocking device with air flow regulation of the ram air, two or more flaps which are arranged parallel to one another are provided with at least one intermediate web as a flap stop. Here, the intermediate webs lead both to cross-sectional constrictions and to noise in the induction region. For tooling reasons, the intermediate webs are overdimensioned since it is barely possible to produce long, narrow plastic webs.

It is an object of the invention to provide an improved air flow regulating device.

Said object is achieved by means of a device having a flap arrangement with the features of claim 1. Advantageous embodiments are the subject matter of the subclaims.

According to the invention, a device having a flap arrangement is provided, which flap arrangement has at least two flap parts which are pivotable about pivot axes which run parallel to one another, the two flap parts bearing against one another in the closed state of the flap arrangement, and rolling and/or sliding on one another during a movement of at least one flap part from the closed state into a partially open state or vice versa. This permits sealing closure, for which purpose at least one of the two flap parts is additionally formed, at least in the bearing region, to be externally elastic, so that sealing closure is possible without an intermediate web as a flap stop. The two flap parts which are associated with one another preferably bear against one another in a planar manner in the closed state. A coating of PP rubber or a foam injection-molded encapsulation is preferably provided in order to form the elastic bearing region. The elastic design also permits relatively large tolerances without impermeability being adversely affected.

The two flap parts preferably have a streamlined profile, so that the flow resistance and thus also the pressure drop can be minimized.

To provide sealing, a stop is preferably provided on the housing in the central region, between the pivot axes, on at least one side of the flap arrangement, said stop ensuring sealing between the flap parts and the housing in the closed state. In addition, one side stop for each flap part is provided on the opposite side.

The invention is explained in detail in the following on the basis of an exemplary embodiment and with reference to the drawing, in which:

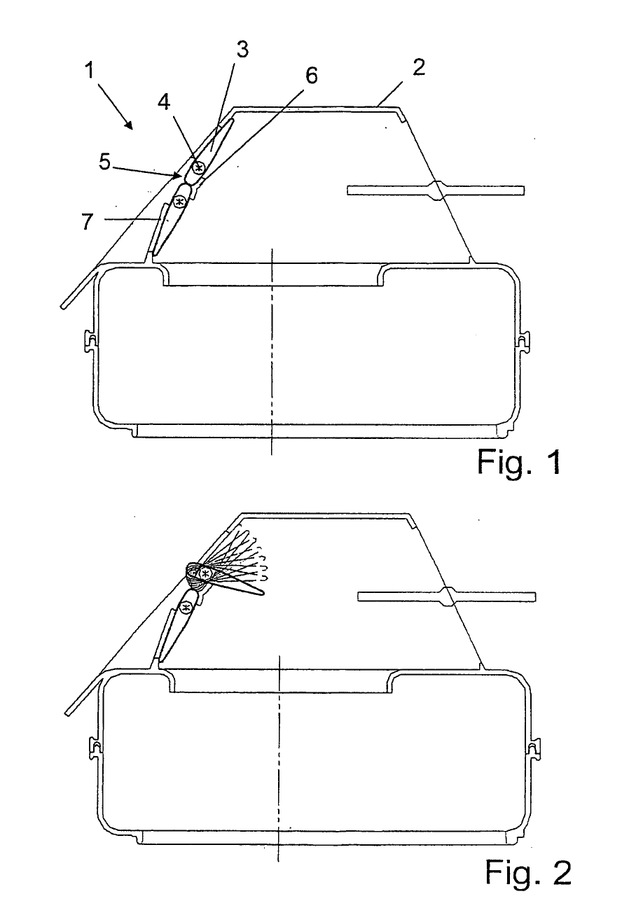

FIG. 1 shows a section through an air guide housing of a motor vehicle air conditioning system having a conventional flap and a flap arrangement according to the invention in a closed position,

FIG. 2 shows the air guide housing from FIG. 1, with various intermediate positions of one of the flap parts being illustrated,

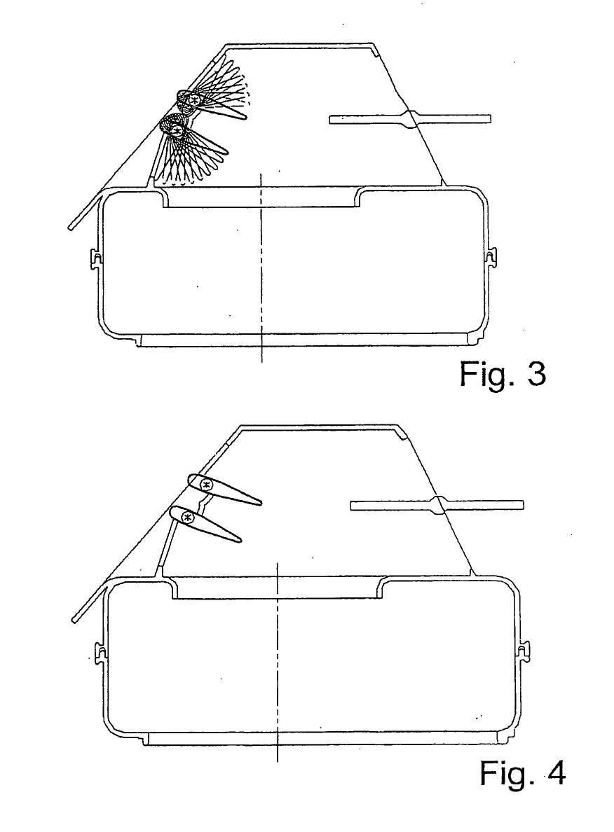

FIG. 3 shows the air guide housing from FIG. 1, with various intermediate positions of both of the flap parts being illustrated,

FIG. 4 shows the air guide housing from FIG. 1 with the flap arrangement in an open position,

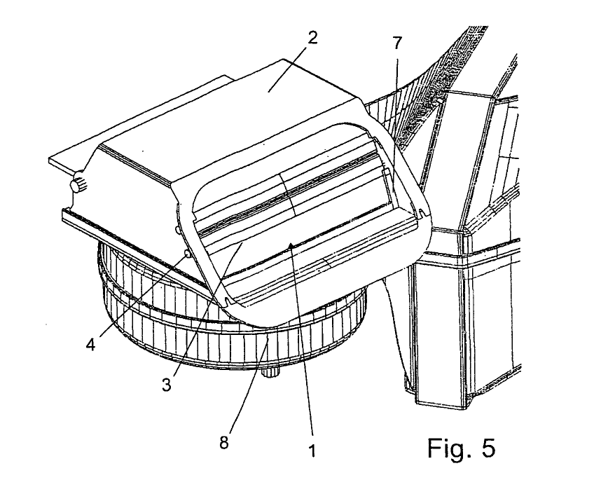

FIG. 5 shows a perspective view of the air guide housing with the flap arrangement closed,

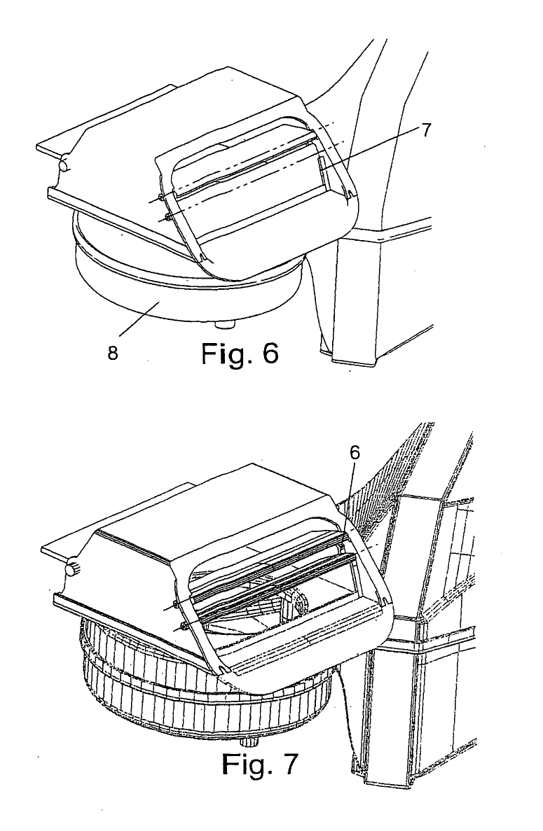

FIG. 6 shows a view corresponding to FIG. 5 with one flap part open and one flap part closed,

FIG. 7 shows a view corresponding to FIG. 5 with the flap arrangement open, and

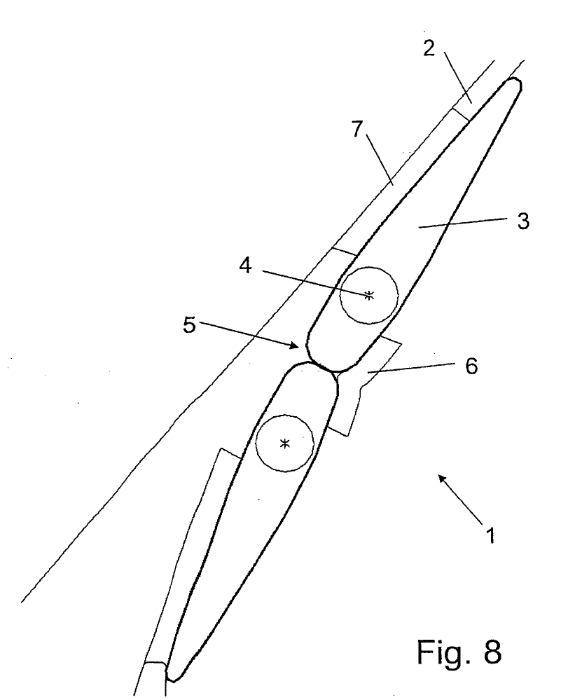

FIG. 8 shows a side view of the flap arrangement in a closed position.

FIG. 1 illustrates an air flow regulating device, having a housing 2 and a flap arrangement 1, of a motor vehicle air conditioning system. An opening, which serves as an inlet opening for fresh air, in the housing wall can be closed and opened by a flap arrangement 1. A further opening, which serves for the supply of recirculated air, is situated in the housing opposite said inlet opening. A conventional twin-blade flap, which is shown in an open position in FIG. 1, is situated as a closing element in the region of said recirculated air inlet opening.

An opening which leads to a region of the housing 2 containing an air-induction fan 8 is situated between the inlet openings for fresh air and for recirculated air.

The flap arrangement 1 comprises two flap parts 3 which are pivotable substantially independently of one another about pivot axes 4 which run parallel to one another. A flap part 3, preferably of streamlined design, has in each case one end which tapers to a point and one end region 5 which is opposite said pointed end and has a substantially circular rounded portion whose diameter substantially corresponds to the maximum thickness of the flap part. The pivot axis 4 of a flap part 3 is situated eccentrically with respect to the flap, said pivot axis 4 being at a greater distance from the tapering end than from the end region 5.

In the position which closes off the fresh air opening, the flap parts 3 are arranged in such a way that the end regions 5 bear sealingly against one another, and the tapering ends, remote from one another, bear against a side stop 7 of the housing 2. The side stops 7 are situated in the region of the end sides of the flap parts 3 and are embodied in the form of narrow webs on the housing 2.

FIG. 2 shows the profile of a pivoting movement of one flap part 3 from the position which completely closes off the fresh air inlet opening, via intermediate positions, to an open position. In said completely open position, the flap part 3 is located by means of a stop 6. The latter is arranged symmetrically between the pivot axes of the flap parts, the contour of said stop 6 sealingly matching the contour formed by the two end regions 5 of the flap parts 3 in the closed position. So as not to obstruct the pivoting movement of the flap parts, the stop 6 has an overall length which approximately corresponds to the distance between the pivot axes 4 minus the thickness of one flap part 3. The central stop 6 is formed as a projecting web on the housing 2 on at least one end side of the flap arrangement 1.

FIG. 3 shows a profile of the pivoting movement of both flap parts 3. The rotational movement of the flap parts can be synchronized or can be independent of one another. In the open limit position of the flap parts 3, as is illustrated in FIG. 4, said flap parts 3 bear against opposite ends of the central stop 6. The flap parts 3 are formed such that they are optimized in terms of flow, so that they have as low an air resistance as possible in said open position. In perspective views of the air flow regulating device, with a view onto the fresh air inlet opening, FIG. 5 shows the flap arrangement 1 in a closed position, the end-side regions of the flap parts 3 bearing against side stops 7, FIG. 6 shows the flap arrangement 1 in a half-closed position, one flap part 3 being open and a second flap part 3 being in a closed position, and FIG. 7 shows the flap arrangement 1 in an open position, the two flap parts 3 bearing against the central stop 6 of the housing.

FIG. 8 shows the flap arrangement 1 in a detailed illustration in order to clarify in particular the sealing function. The pivot-axis-side end region 5 of a flap part 3 is formed to be substantially circular over a substantial part. Here, the end regions 5 are formed to be elastic in at least their outer region. A foam injection-molded encapsulation of the flap parts 3 in the end regions 5 is provided for this purpose. The two pivot axes 4 are at a smaller distance from one another than the sum of the distances of the outermost parts of the end regions 5 from the associated pivot axes 4 of the two flap parts 3, so that the end regions 5 at least partially roll and/or slide on one another during the closing or opening movement, said end regions 5 being slightly elastically deformed and ensuring sealing closure. To provide lateral sealing, at least one central stop 6 and two side stops 7 are provided, which make good sealing possible as a result of the symmetrical arrangement of the flap parts 3.

### LIST OF REFERENCE SYMBOLS

1 Flap arrangement
2 Housing
3 Flap part
4 Pivot axis
5 End region
6 Stop
7 Side stop
8 Fan

1. An air flow regulating device having a housing and a flap arrangement with at least two flap parts for opening and closing an opening which are pivotable about pivot axes which run parallel to one another, wherein end regions of the two flap parts bear against one another in the closed state of the flap arrangement, and roll and/or slide on one another during a movement of at least one flap part from the closed state into a partially open state or vice versa.

2. The device as claimed in claim 1, wherein at least one of the two flap parts is formed, at least in the bearing region, to be externally elastic.

3. The device as claimed in claim 1, wherein the closed state, the two flap parts are in planar contact.

4. The device as claimed in claim 1, wherein the two flap parts have a streamlined profile.

5. The device as claimed in claim 1, wherein a stop is provided on the housing in the central region between the pivot axes on at least one side of the flap arrangement.

6. The device as claimed in claim 1, wherein one side stop is provided on the housing on each side of the flap arrangement.

7. The device as claimed in claim 5, wherein the central stop and the two side stops are arranged on mutually opposing sides of the flap parts.

8. The device as claimed in claim 1, wherein the flap parts have a coating of PP rubber or a foam injection-molded encapsulation.

9. An air conditioning unit, in particular for motor vehicles, wherein the air conditioning unit contains a device as claimed in claim 1.

10. The air conditioning unit as claimed in claim 9, wherein the air conditioning unit comprises at least one of the following components: heat exchanger, radiator, evaporator, filter, temperature mixing flap, mixing chamber, one or more flow ducts and one or more control flaps for distributing the air to the outlet ducts.
